(19) United States
(12) Patent Application Publication
(10) Pub. No.: US 2010/0201532 A1
(43) Pub. Date: Aug. 12, 2010

(54) METHOD AND APPARATUS FOR PROVIDING ALARM FUNCTION IN PORTABLE TERMINAL HAVING PROJECTION FUNCTION

(75) Inventor: Han Shil CHOI, Seoul (KR)

Correspondence Address: CHA & REITER, LLC, 210 ROUTE 4 EAST STE 103, PARAMUS, NJ, 07652, US

(73) Assignee: SAMSUNG ELECTRONICS CO., LTD., Gyeonggi-Do (KR)

(21) Appl. No.: 12/703,908

(22) Filed: Feb. 11, 2010

(30) Foreign Application Priority Data
Feb. 10, 2009 (KR) 10-2009-0010404

(51) Int. Cl. G08B 21/00

(52) U.S. Cl. 340/635

(57) ABSTRACT

A method and apparatus that provides user alarm information using a projection function of a portable terminal. The method includes checking setting information regarding the alarm function when a preset alarm time arrives, driving a projector module if the alarm function is set to output a video content, and outputting video data contained in the video content to an exterior of the portable terminal preferably through the projector module.

### CLAIM OF PRIORITY

The present application claims the benefit of priority from Korean Patent Application No. 10-2009-0010404, filed on Feb. 10, 2009, the contents of which is hereby incorporated by reference in its entirety.

### BACKGROUND OF THE INVENTION

1. Field of the Invention

The present invention relates to alarm functions for devices such as portable terminals. More particularly, the present invention relates to a method and apparatus that provides particular alarm information set by a user for output.

2. Description of the Related Art

In recent years, with the development of digital technology, a variety of portable terminals have been developed that can perform communications and process user information while being moved. Examples of such portable terminals include mobile communication terminals, personal digital assistants (PDAs), electronic organizers, etc. Portable terminals are typically equipped with a screen display unit and display screen data thereon. The screen display unit is generally relatively small since the portable terminals themselves are small, many fitting within the palm of one's hand.

Although a user can view information via a small-sized screen display unit of the portable terminal by himself/herself, it is hard to show the information to other people. For example, there has been developed a TV-out function, a function that was created for displaying information stored in a portable terminal on an external large-scale display device so as to share it with other people. In that case, a connection means is needed to connect between the portable terminal and the external large-scale display device, which causes inconvenience to users.

Conventional portable terminals display screen data on their small-sized display unit. The display unit, installed in conventional portable terminals, is typically implemented with a liquid crystal display (LCD), or an organic light emitting diode (OLED), etc.

Since conventional display units have such small screens, they cause a great deal of inconvenience to users when playing a mobile game or viewing a digital broadcast, where it may be difficult to pick up detailed portions of the image necessary to play the game or view the image. Therefore, the display units for such uses would be desirable if equipped with a large screen, so that they can increase the user viewing satisfaction. It should also be noted that large screens, which are desirable for mobile games or viewing digital broadcast, are undesirable in terms of portability and compactness of the portable terminal.

In recent years, there have been many attempts to provide an image projection function for a mobile communication terminal so that an image can be displayed on a large screen. For example, a great deal of research has been conducted regarding portable terminals that are equipped with a projector and provide images on a large screen, such as a wall, etc.

### SUMMARY OF THE INVENTION

The present invention provides a method and apparatus that controls functions of a portable terminal having a projection function and can provide user alarm information, via the portable terminal, using the projection function.

The present invention further provides a method and apparatus that simultaneously provides an audible component and a visual component, included in particular alarm information set for output by a user in a portable terminal having a projection function.

In accordance with an exemplary embodiment of the present invention, a method for providing an alarm function in a portable terminal, preferably includes: checking setting information regarding an alarm function that has been set when a preset alarm time arrives; driving a projector module if the alarm function is set to output a video content; and outputting video data contained in the video content exterior to the portable terminal through the projector module.

In accordance with another exemplary embodiment of the present invention, a portable terminal apparatus preferably includes: a storage unit for storing alarm setting information regarding an alarm function; a projector module for projecting video data exterior to the portable terminal; and a controller for driving the projector module corresponding to the alarm setting information and for controlling the projector module to output video data corresponding to the alarm information, when the alarm function is enabled.

### BRIEF DESCRIPTION OF THE DRAWINGS

The following features and advantages of the present invention will become more apparent to a person of ordinary skill in the art from the following detailed description in conjunction with the accompanying drawings, in which:

FIG. 1 is a flow chart that describes a method for providing alarm information in a portable terminal having a project ion function, according to an exemplary embodiment of the present invention;

FIG. 2A to FIG. 2C show screens displaying alarm information in a portable terminal having a projection function, according to an exemplary embodiment of the present invention; and

FIG. 3 is a schematic block diagram illustrating the configuration of a portable terminal according to an exemplary embodiment of the present invention.

### DETAILED DESCRIPTION

Hereinafter, exemplary embodiments of the present invention are described in detail with reference to the accompanying drawings. The same reference numbers are used throughout the drawings to refer to the same or similar parts. Detailed descriptions of well-known functions and structures incorporated herein may be omitted to avoid obscuring appreciation of the subject matter of the present invention by a person of ordinary skill in the art.

In an exemplary embodiment of the present invention, a portable terminal having a projection function will be explained in detail. A description is also provided regarding a method and apparatus that can provide particular alarm information, set by a user, in a portable terminal equipped with a projector module, and maximize the visual effect to transfer the alarm information, through the projection function. The alarm information refers to audio data and/or video data that are related to various types of contents to set a morning call alarm, a schedule alarm, etc.

The portable terminal according to an exemplary embodiment of the present invention includes a projection function, a function for reproducing multi-media contents, such as video contents, audio contents, etc., a function for receiving and reproducing a digital broadcast, a document viewing function, etc. When the portable terminal performs the function for reproducing multi-media contents, the function for reproducing a digital broadcast, and the document viewing function, it can maximize and display screen data corresponding to the function on an external screen, via the projection function.

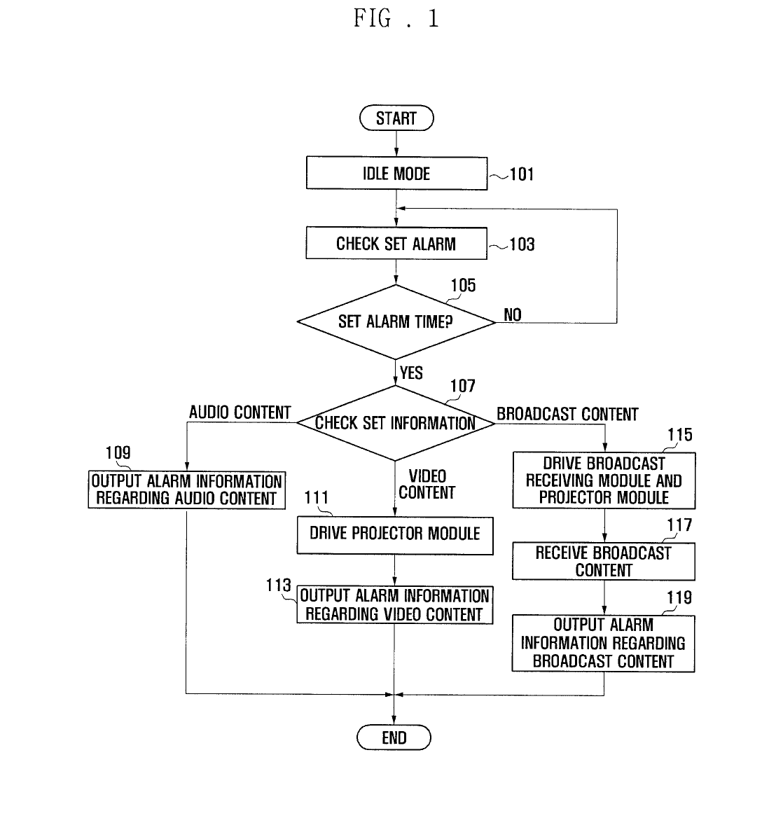

In the following description, a method for providing an alarm information set in a portable terminal equipped with a projector module is provided, with reference to FIG. 1. It should be understood, however, that the presently claimed invention is not limited to the exemplary embodiments herein. It will be appreciated that there are many modifications from the exemplary embodiment of the present invention.

FIG. 1 is a flow chart that describes a method for providing alarm information in a portable terminal having a projection function, according to an embodiment of the present invention. In an exemplary embodiment of the present invention, it is assumed that, although it is not shown in FIG. 1, a particular alarm, for purposes of this example, a morning call alarm, a schedule alarm, etc., has been set in the portable terminal.

Referring to now FIG. 1, the portable terminal is operated in an idle mode step (101), and checks a set alarm step (103). When a user has set an alarm in the portable terminal, at step (105) the portable terminal checks whether the set alarm time arrives. The set alarm may be a sound alert according to a morning call function, or may comprise a preset alarm according to a certain function.

If, at step (105), the portable terminal ascertains that the set alarm time does not arrive, the portable terminal detects a set alarm step (103). On the contrary, if the portable terminal ascertains that the set alarm time has arrived at 105, at step (107) set information regarding the alarm is checked. The set information according to an embodiment of the present invention is established as the following Table 1.

TABLE 1
Alarm setting information

| | | |
|---|---|---|
| Time settings | Alarm time information | |
| Audio content | Activation/Deactivation | Additional |
| | | information |
| | | setting |
| Video content | Activation/Deactivation | Additional |
| | | information |
| | | setting |
| Broadcast | Activation/Deactivation | Additional |
| content | | information |
| | | setting |
| Projection | Activation/Deactivation | |
| function | | |

As indicated by Table 1, a user can set an alarm time and an alarm generating mode with respect to a morning call alarm or an alarm according to a schedule. The alarm generating mode refers to modes for outputting alarm information regarding an audio content, i.e., audio data, alarm information regarding a video content, i.e., video data and audio data, and alarm information regarding a broadcast content, i.e., video data and audio data. When one of the alarm output modes is activated or deactivated, an alarm setting process for a corresponding alarm has completed. In particular, when an alarm is set using a video content and a broadcast content, a mode for outputting video data is also set. That is, an alarm can be set by combining a projection function that can display video data on an external screen using a projector module by a projection function. In addition, when an alarm is set, additional information can also beset. For example, a volume related to an audio content, a video content, and a broadcast content, a broadcast channel, an alarm duration, etc.

As such, when a user set a morning call alarm or an alarm for a schedule, an alarm content can also be selected from among the audio content, the video content, and the broadcast content. An alarm can be set, for example, by selecting the audio content, which corresponds to a conventional alarm setting method. If an alarm is set by the user selecting for output the video content or the broadcast content, then video data of a video content or a broadcast content, selected by the user is projected to an external screen, for example, a wall or floor, through a projector module of the portable terminal.

Referring now back to the flowchart of FIG. 1, at step (107), the portable terminal checks the setting information, as described in Table 1, and then performs corresponding functions, which will be explained as follows.

If the portable terminal ascertains at step (107) that an alarm has been set for output of the audio content, the portable terminal extracts a set audio content and outputs alarm information corresponding to the audio content, i.e., audio data, to a speaker SPK at step (109).

However, if at step (107) the portable terminal ascertains that an alarm has been set for output of the video content, the portable terminal extracts a set video content and outputs alarm information corresponding to the video content, i.e., video data and audio data. The alarm information is output to the speaker SPK and a display unit, respectively. That is, video data and audio data are provided to the display unit and the speaker SPK, respectively.

When the portable terminal outputs the alarm information according to the video content, the portable terminal checks whether a projection function is activated. If the portable terminal ascertains that a projection function has been activated, at step (111) the portable terminal then drives a projector module. After that, the portable terminal outputs video data of the video content to an external screen via the projector module, and outputs the related audio data to the video content to the speaker SPK (113). Simultaneously, the display unit can also display the video data or a preset screen. Examples of the screen will be described later.

However, if, at step (107), the portable terminal ascertains that an alarm has been set for output of the broadcast content, the portable terminal drives a broadcast receiving module (115), and then at step (117) receives a broadcast content via a preset channel or a previously activated channel. After that, at step (119), the portable terminal outputs an alarm information corresponding to the broadcast content, i.e., video and audio data (119). The video data and the audio data of the alarm information are output to the display unit and the speaker SPK, respectively.

When the portable terminal is about to output the alarm information according to the broadcast content, the portable terminal checks whether a projection function is activated. If the projection function has been activated, at step (115) the portable terminal drives the projector module and the broadcast receiving module. After that, the portable terminal outputs the video data of the broadcast content to an external screen via the projector module and the audio data of the broadcast content to the speaker SPK. Simultaneously, the display unit can also display the video data or a preset screen. Examples of the screen will be subsequently described herein.

Although not shown in FIG. 1, when the alarm function is released according to a user's request, the following processes may be further performed.

In other words, when the alarm function according to a video content is released, the projector module driven by the alarm function is turned off, so the process of outputting the video data by the projector module can also be released. When the alarm function according to a broadcast content is released, the broadcast receiving module and the projector module, which are both driven by the alarm function, are turned off, so the processes of receiving the broadcast content by the broadcast receiving module and of outputting video data by the projector module can also be released.

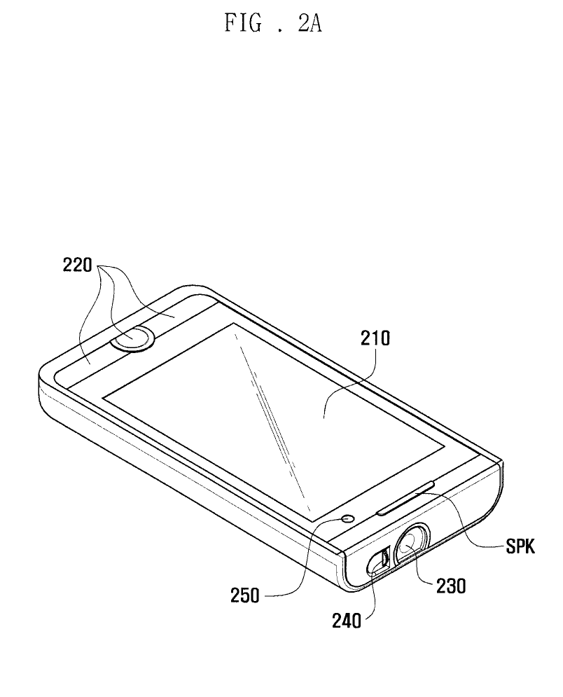

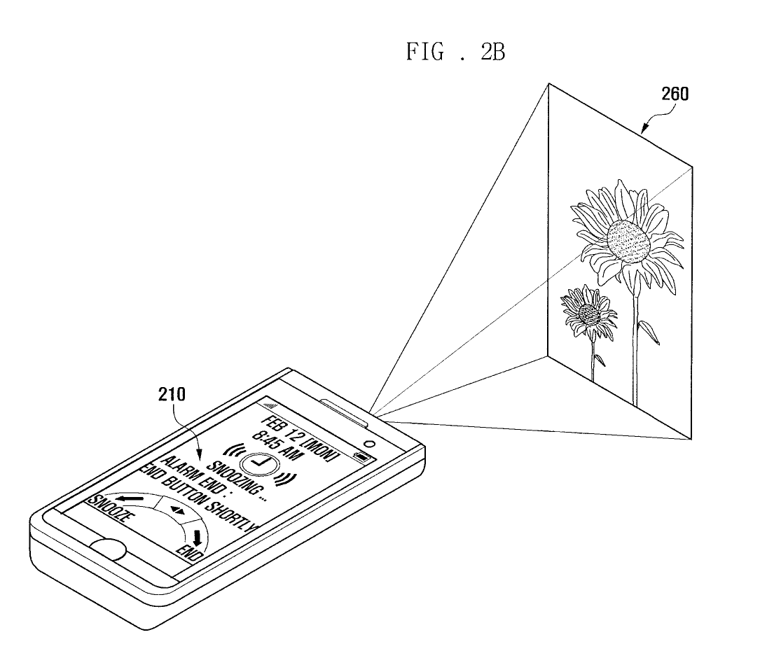

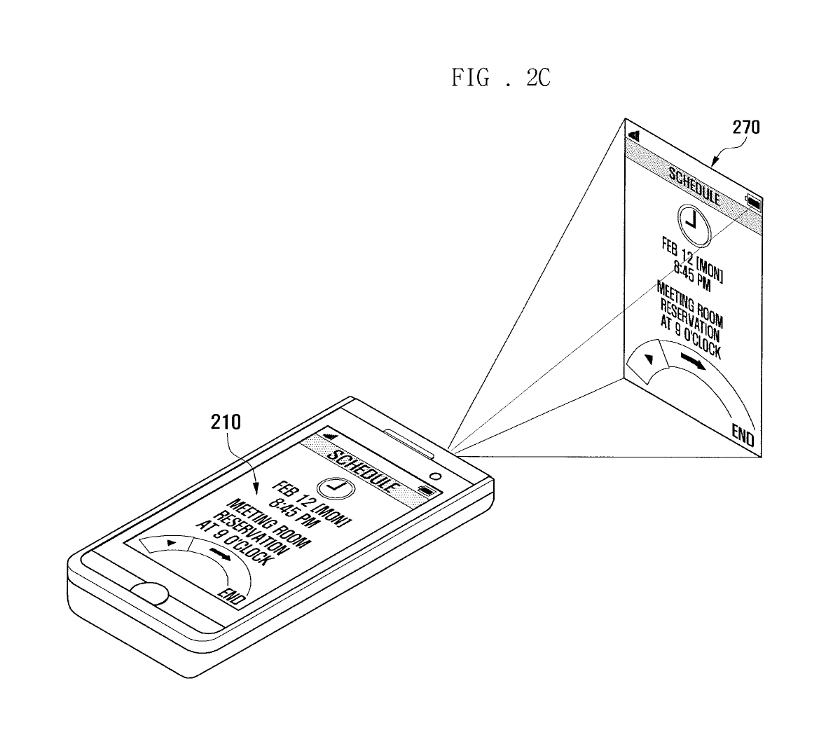

In the foregoing description, an exemplary method has been explained that provides alarm information in a portable terminal with a projector module according to an exemplary embodiment of the present invention. In the following, examples of a process for outputting alarm information, according to the alarm generating modes, will now be explained with reference to FIGS. 2A to 2C. It should be understood, however, that the present invention is not limited to the exemplary embodiments discussed herein. A person of ordinary skill in the art will be appreciate that there are many modifications of the exemplary embodiments of the present invention that are within the spirit of the invention and the scope of the appended claims.

FIG. 2A to FIG. 2C show screens displaying alarm information in a portable terminal having a projection function, according to an exemplary embodiment of the present invention.

FIG. 2A shows a portable terminal that operates during an idle mode to turn off the display unit 210. FIG. 2B shows a portable terminal that outputs alarm information regarding a particular video content, i.e., video data, to an external screen through a projector module 230, when a morning call alarm function is activated. FIG. 2C shows a portable terminal that outputs alarm information regarding a schedule content, i.e., schedule data, to an external screen through a projector module 230, when a schedule alarm function is activated.

Referring now to FIGS. 2A to 2C, the portable terminal according to this exemplary embodiment of the present invention preferably includes a display unit 210, an input unit 220, a projector module 230, a focus controlling unit 240, a speaker SPK, and a camera module 250. The display unit 210 displays various types of screen data according to the operations of the portable terminal. The input unit 220 receives control signals typically input by a user. The projector module 230 projects video data from the portable terminal to an external screen (or external surface, such as a wall) to make the projected video data large. The focus adjusting unit 240 permits adjustment of the focus of the projector module 230. The speaker SPK outputs audio data of the audio content. The camera module 250 serves to provide a video communication service. It is preferable that the camera module 250 is installed in front of the portable terminal.

In the following, a detailed description is provided regarding a method for outputting alarm information, according to an exemplary embodiment of the present invention, with reference to FIGS. 2A to 2C.

In order to output alarm information according to the audio content, the portable terminal, which is in an idle state as shown in FIG. 2A, proceeds to output alarm information corresponding to an audio content, i.e., audio data, through the speaker SPK. According to the setting modes, the portable terminal displays a screen data set according to the alarm generating modes on the display unit 210.

In order to output alarm information according to the video content/broadcast content, the portable terminal is typically initially in an idle state, as shown in FIG. 2A, and then outputs alarm information containing an audio portion of video content, i.e., audio data, through speaker SPK. Simultaneously, the portable terminal also outputs alarm information containing the video content, i.e., video data 260, to the external screen through the projector module 230 as shown in FIG. 2B.

The external screen may be implemented with various types of members to which video data can be projected, for example, a white screen, a wall, a floor, etc. As shown in FIG. 2B, when the alarm information according to the video content/broadcast content is output, the portable terminal can output screen data on the display unit 210 while outputting video data 260, which differs from the screen data, on the external screen. For example, while the screen data for controlling a morning call function is being displayed on the display unit 210, video data contained in the video content/broadcast content is also displayed on the external screen.

In order to output the alarm information according to a scheduled alarm function, the portable terminal is initially in an idle state as shown in FIG. 2A, and then outputs alarm information corresponding to a schedule content through the speaker SPK, i.e., audio/video data set to indicate that a preset schedule time has arrived. Simultaneously, as shown in FIG. 2C, the portable terminal outputs alarm information contained in the schedule content, i.e., schedule data 270, to the external screen, through the projector module 230.

As shown in FIG. 2C, when the portable terminal outputs alarm information according to the scheduled alarm function, the portable terminal can output screen data on the display unit 210 while outputting video data 260, which is identical to the screen data, on the external screen. For example, while schedule data according to a schedule alarm function is being displayed on the display unit 210, the portable terminal can also display the schedule data on the external screen in a large scale.

In the foregoing description, the method has been explained that can provide user alarm information in a portable terminal equipped with a projector module, using a projection function. In the following description, the operations of the portable terminal apparatus according to the present invention will now be explained. It should be understood, however, that the present invention is not limited to the embodiment. It will be appreciated by a person of ordinary skill in the art that there are many modifications of the exemplary embodiments of the present invention that are within the spirit of the invention and the scope of the appended claims.

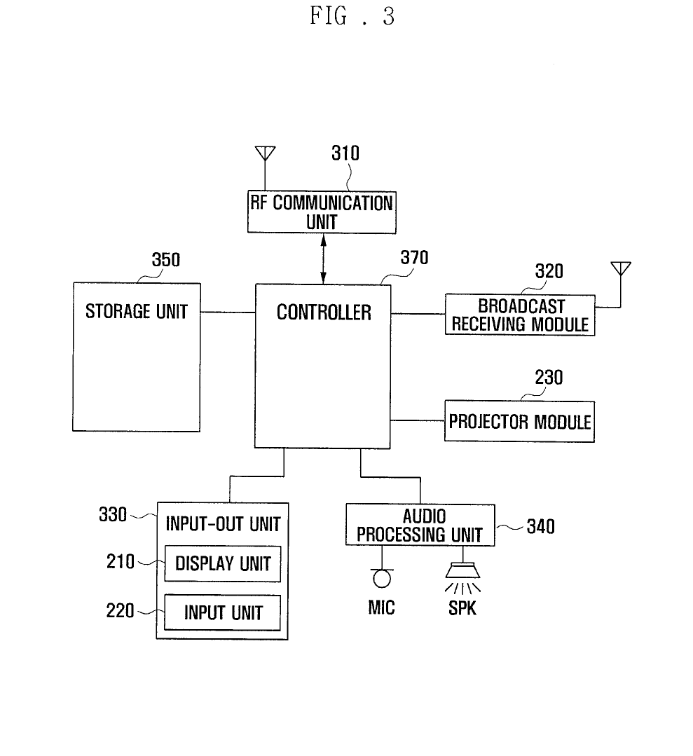

In an exemplary embodiment of the present invention, although the portable terminal is explained based on a mobile communication terminal, a person of ordinary skill in the art should be understood that the present invention is not limited to the exemplary embodiments shown and described herein. That is, the portable terminal refers to any terminal(s) that can set an alarm function and includes a projector module. The portable terminal can be applied to all mobile communication terminals that can be operated with communication systems based on various communication protocols. It will be appreciated that the portable terminal can also be applied to all information communication devices, multimedia devices, and their applications, such as, a portable multimedia player (PMP), a digital broadcast player, a personal digital assistant (PDA), a portable game player, a smart phone, etc. The following description is provided regarding the configuration of the portable terminal according to an exemplary embodiment of the present invention with reference to FIG. 3.

FIG. 3 is a schematic block diagram illustrating the configuration of a portable terminal according to an exemplary embodiment of the present invention.

Referring now to FIGS. 1 and 3, and particularly with reference to FIG. 3, the portable terminal includes an RF communication unit 310, a broadcast receiving module 320, an input-output unit 330, an audio processing unit 340, a storage unit 350, a projector module 230, and a controller 370.

The RF communication unit 310 allows the portable terminal to perform communication with other portable terminals. The RF communication unit 310 establishes a communication channel with a mobile communication network and performs communication, such as a voice call, a video telephony call, data call, etc. RF communication unit 310 preferably includes an RF transmitter for up-converting the frequency of transmitted signals and amplifying the transmitted signals and an RF receiver for low-noise amplifying received RF signals and down-converting the frequency of the received RF signals. The RF communication unit 310 may not be installed in the portable terminal, according to the type of portable device being used.

The broadcast receiving module 320 receives broadcast contents from a broadcast station or a broadcast server, and outputs them to the controller 370. The broadcast receiving module 320 extracts additional broadcast information, such as electronic program guides, from the broadcast contents, and receives broadcast contents corresponding to a channel based on the extracted additional broadcast information. The video data of the broadcast contents output from the broadcast receiving module 320 may be displayed on the display unit 210 and output to the external screen through the projector module 230 (such as shown in FIG. 2A). That is, the video data of the broadcast contents, received by the broadcast receiving module 320, may be projected through the projector module 230, under the control of the controller 370. The video data may be provided to the display unit 210 and the projector module 230 or only to the projector module 230. When a particular alarm time set by a user arrives, the broadcast receiving module 320 is driven to receive broadcast contents via a corresponding broadcast channel, under the control of the controller 370. The corresponding broadcast channel may comprise a broadcast channel selected by a user, or a broadcast channel that has received a broadcast content.

With continued reference to FIG. 3, the input-output unit 330 is typically comprised of, for example, a display unit 210 and an input unit 220. The display unit 210 is preferably implemented with a liquid crystal display (LCD), an organic light emitting diode (OLED), or a touch screen. The input unit 220 is preferably implemented with at least one of a touch pad, a keypad, dome keys, and function keys, or a combination thereof. The input-output unit 330 may be implemented with only the display unit 210. In such a case, it is preferable that the display unit 210 is implemented with a touch screen. A touch screen serves to simultaneously perform input and output functions. In an exemplary embodiment of the present invention, the touch screen is comprised of a display area, such as an LCD or an OLED, and a touch area including touch sensors.

The display area displays various screen data generated when the portable terminal is executed, and also state information according to a user's operation and the function controls of the portable terminal. That is, the display area displays various types of screen data related to the states and operations of the portable terminal. The display area displays signals and color information, output from the controller 370. In an exemplary embodiment of the present invention, the display area may display video data generated by the controller 370 when the portable terminal performs the projection function or screen data of a particular graphical user interface (GUI) for controlling a corresponding function.

The touch area receives a user's input event. In particular, the touch area preferably receives a variety of events for controlling functions related to the applications of the portable terminal. Examples of the events are a tap, a drag, a flick, a sweep, etc. When the touch area receives an event input by a user, the touch area outputs coordinate information where the input event has occurred to the controller 370. That is, the touch area detects a touch input by the user, generates a signal corresponding to the touch action, and then outputs the signal to the controller 370.

The input unit 220 receives character information and receives signals related to the settings for a variety of functions and the control signals. The input unit 220 preferably outputs the input information to the controller 370. The input unit 220 generates an input signal according to a user's action. To this end, the input unit 220 is implemented with at leas one of a keypad, function keys, dome keys, and a touch pad. Alternatively, the input unit 220 may not be included in the portable terminal.

The audio processing unit 340 is connected preferably to a microphone MIC and a speaker SPK. The audio processing unit 340 coverts a voice signal received by the microphone MIC into data and outputs it to the controller 370 and outputs a voice signal from the controller to the speaker SPK. That is, the audio processing unit 340 converts an analog voice signal that is received by the microphone MIC into a digital voice signal, and outputs the digital voice signal to the controller 370. The audio processing unit 340 also converts a digital voice signal from the controller 370 into an analog voice signal and outputs it through the speaker SPK. The audio processing unit 340 can reproduce a variety of audio components generated by the portable terminal according to a user's selection. An example of the audio component is an audio signal generated as a moving image file or a music file is reproduced. Alternatively, the audio processing unit 340 may not include a voice signal processing function according to types of portable terminals.

The storage unit 350 includes read only memory (ROM), random access memory (RAM), etc. The storage unit 350 may store various types of data generated or used in the portable terminal. The various types of data include, for example, data generated as application programs are executed in the portable terminal, data generated by using the portable terminal, and data downloaded from external systems, for example, a base station, other portable terminal, a personal computer, etc. In an exemplary embodiment of the present invention, the various types of data include user interfaces for the portable terminal, setting information related to the operations of the portable terminal, setting information related to alarm function settings, audio contents, video contents, broadcast contents, and setting information for controlling the operations according to the projection function.

The storage unit 350 stores an application program for controlling the entire operation of the portable terminal, and also stores an application program for providing alarm information using a projection function. The application program for providing alarm information performs the processes, for example, as shown in FIG. 1, FIGS. 2A to 2C, and FIG. 3. These application programs are stored in an application storage area (not shown) of the storage unit 350. The storage unit 350 may further include one or more buffers that can temporarily store data that are generated when the application programs are executed and the portable terminal is operated.

The projector module 230 is installed within the portable terminal and projects the video data, output from the controller, on the external screen via a lens that normally significantly increases the size of the data as compared to outputting same on the display unit 210. That is, the projector module 230 projects video data, processed by the controller 370, to the external screen without distortion, and normally increases of the size projection so as to be much, larger than the size of the display unit 210.

Still referring to FIG. 3, the controller 370 controls the entire operation of the portable terminal and signal flows among elements in the portable terminal. Examples of the elements are the RF communication unit 310, the broadcast receiving module 320, the input-output unit 330, the audio processing unit 340, the storage unit 350, and the projector module 230.

In an exemplary embodiment of the present invention, the controller 370 can control the output of the user alarm information using a projection function. The controller 370 compares a current time with a preset alarm time and determines whether the preset alarm time arrives. If the preset alarm time has arrived, the controller 370 controls an outputting process of alarm information corresponding to the alarm setting information. That is, the controller 370 controls the outputting of alarm information by the audio content, the video content, and the broadcast content, based on the alarm setting information. In particular, when the alarm function by the video content or the broadcast content is processed, the controller 370 controls a series of processes for outputting alarm information to an external screen via the projector module.

When the alarm function by outputting the video content is released, the controller 370 turns off the projector module 230 and thus releases the output of the video data by the projector module 230. Similarly, when the alarm function by outputting the broadcast content is released, the controller 370 turns off the broadcast receiving module 320 and the projector module 230 and thus release the output of the video data by the projector module 230.

In an exemplary embodiment of the present invention, although the controller 370 controls the entire operation of the portable terminal as shown in FIG. 1, FIGS. 2A to 2C, and FIG. 3, a person of ordinary skill in the art should understand that the exemplary embodiment may be modified such that the entire function can be implemented in whole or in part with software.

In an exemplary embodiment of the present invention, although FIG. 3 schematically shows the configuration of the portable terminal for the sake of convenience, a person of ordinary skill in the art should understand that the presently claimed invention is not limited to the examples shown and discussed herein.

For example, the controller 370 may further include a baseband module for providing a mobile communication service of the portable terminal. The baseband module may be either installed to the controller 370 and the RF communication unit 310, respectively, or separately therefrom.

Although not shown in the drawings, the portable terminal may further include other elements to achieve additional functions, for example, a camera module for capturing images and acquiring image data, a short-range communication module, an Internet communication module for performing communication with an Internet network. Thus, the claimed invention is not limited to a portable terminal with only the described features, but rather is broad and may include any device having an alarm function as claimed herein.

With the convergence of digital devices, there may be many digital devices and modifications thereof, not listed in the application, and, it will be appreciated that they can also be included in the portable terminal. Also, a person of ordinary skill in the art will be appreciate that, according to the purposes, the portable terminal may be implemented by omitting a particular element or replacing a particular element with other elements.

As described above, the alarm function providing a method and apparatus according to the present invention can output a morning call alarm or a scheduled alarm, through visual components as well as audible components using audio contents such as a voice message or a ring tone, etc. When an alarm time set for a morning call or a scheduled time arrives, the portable terminal outputs the alarm information, such as video contents, audio contents, broadcast contents, schedule contents, etc., to an external screen and a speaker SPK, using a projection function. That is, the portable terminal can perform an alarm function by simultaneously outputting a visual component and an audible component contained in the contents.

As described above, the alarm function providing method and apparatus according to the present invention can provide alarm information through an external large screen when a preset alarm time arrives, thereby maximizing the visual effect to transfer the alarm information to a user. When the portable terminal performs a morning call function or alarm function, the portable terminal can display video content on an external screen in a large scale while outputting voice content to a speaker. Therefore, the portable terminal can effectively transfer the alarm information to the user. The portable terminal can perform a morning call function or alarm function, associated with a variety of contents, for example, broadcast contents, thereby effectively transferring the alarm information to a user.

Although exemplary embodiments of the present invention have been described in detail hereinabove, a person of ordinary skill in the art should understand that many variations and modifications of the basic inventive concept herein described, which may be apparent to those skilled in the art, will still fall within the spirit and scope of the exemplary embodiments of the present invention as defined in the appended claims. For example, the portable terminal may include an interface (including but not limited in any way to USB or IEEE 1394) and an I/O port, including but in no way limited to an IrDA port or IEEE 802.11-based port for a receiving or communicating with an external storage device that contains the video content for output by the projector module when the alarm function is appropriately set.

The above-described methods according to the present invention can be realized in hardware or as software or computer code that can be stored in a recording medium such as a CD ROM, a RAM, a floppy disk, a hard disk, or a magneto-optical disk or downloaded over a network, so that the methods described herein can be executed by such software using a general purpose computer, or a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein.

What is claimed is:

1. A method for providing an alarm function in a portable terminal, the method comprising:
checking setting information regarding an alarm function that has been set when a preset alarm time arrives;
driving a projector module if the alarm function is set to output a video content; and
outputting video data contained in the video content exterior to the portable terminal through the projector module.

2. The method of claim 1, wherein outputting video data includes additionally outputting screen data for controlling the alarm function to a display unit.

3. The method of claim 2, wherein outputting video data further comprises:
outputting on the display unit screen data of a same type as the video data projected by the projector module.

4. The method of claim 2, wherein outputting video data further includes outputting to a speaker audio data contained in the video content.

5. The method of claim 1, further comprising:
driving a broadcast receiving module and the projector module when the alarm function is set to output a video content that is comprised of a broadcast content;
receiving the broadcast content via a particular broadcast channel; and
outputting video data contained in the received broadcast content exterior to the portable terminal via the projector module.

6. The method of claim 5, wherein outputting video data contained in the broadcast content comprises:
outputting screen data for controlling the alarm function to a display unit.

7. The method of claim 6, wherein outputting video data contained in the broadcast content further comprises:
outputting screen data on the display unit of a same type as the video data projected by the projector module.

8. The method of claim 6, further comprising:
outputting audio data contained in the broadcast content by a speaker.

9. The method of claim 2, further comprising:
turning off the projector module when the alarm function is released; and
releasing the output of the video data by the projector module.

10. The method of claim 5, further comprising:
turning off the broadcast receiving module and the projector module when the alarm function is released; and
releasing the output of the video data by the projector module.

11. A portable terminal comprising:
a storage unit for storing alarm setting information regarding an alarm function;
a projector module for projecting video data exterior to the portable terminal; and
a controller for driving the projector module corresponding to the alarm setting information and for controlling the projector module to output video data corresponding to the alarm information, when the alarm function is enabled.

12. The portable terminal of claim 11, further comprising:
a display unit for outputting a variety of screen data;
wherein, if the alarm function is set to output a video content, the controller outputs video data contained in the video content through the projector module and displays screen data for controlling the alarm function on the display unit.

13. The portable terminal of claim 12, wherein the controller outputs screen data to the display unit of a same type as the video data output through the projector module.

14. The portable terminal of claim 12, further comprising:
a broadcast receiving module for receiving a broadcast content,
wherein, if the alarm function is set to output a broadcast content, the controller drives the broadcast receiving module and the projector module and controls the projector module to output video data contained in the received broadcast content to the exterior of the portable terminal.

15. The portable terminal of claim 14, wherein the controller controls the display unit to output screen data for controlling the alarm function when the video data of the broadcast content is output through the projector module.

16. The portable terminal of claim 15, wherein, when the video data of the broadcast content is output through the projector module, the controller controls the display unit to output screen data that is the same type as the video data of the broadcast content.

17. The portable terminal of claim 12, wherein, when the alarm function is released, the controller turns off the projector module and releases the output of the video data by the projector module.

18. The portable terminal of claim 14, wherein, when the alarm function is released, the controller turns off the broadcast receiving module and the projector module and releases the output of the video data output by the projector module.
